(19) United States
(12) Patent Application Publication
(10) Pub. No.: US 2024/0061449 A1
(43) Pub. Date: Feb. 22, 2024

(54) Systems and Methods for High-speed Geofencing

(71) Applicant: California Institute of Technology, Pasadena, CA (US)

(72) Inventors: Aaron D. Ames, Pasadena, CA (US); Andrew W. Singletary, Pasadena, CA (US)

(73) Assignee: California Institute of Technology, Pasadena, CA (US)

(21) Appl. No.: 18/324,042

(22) Filed: Nov. 8, 2023

Related U.S. Application Data
(60) Provisional application No. 63/345,864, filed on May 25, 2022.

(51) Int. Cl. G05D 1/10; B64U 50/19; G06F 17/17

(52) U.S. Cl. CPC G05D 1/106; B64U 50/19; G06F 17/17; B64U 2201/10

(57) ABSTRACT

Systems and methods for performing high-speed geofencing in accordance with various embodiments of the invention are disclosed. One embodiment includes a robotics platform including a set of one or more motors, at least one sensor, a controller comprising a set of one or more processors, and a memory containing a controller application and a backup controller application, wherein the controller application configures the set of processors to control the robotics platform by performing the steps of receiving user commands, generating commands controlling the set of one or more motors based on the received commands. The backup controller application configures the set of processors to monitor the controller and intervene as the commands received by the controller direct the robotics platform towards a boundary by performing the steps of defining a safe set identifying positions where the robotics platform is safe, defining an invariant safe set based upon a backup set, where the invariant safe set is a subset of the safe set, and the backup set is a subset of both the invariant safe set and the safe set, receiving commands controlling the set of one or more motors to track to a desired velocity, determining if the robotic platform is approaching, and upon a determination that the robotics platform is approaching a boundary of the invariant safe set, switching control of the motors from the received commands to a combination of the received commands and backup controls generated by the backup controller application.

### CROSS-REFERENCE TO RELATED APPLICATIONS

The present invention claims priority to U.S. Provisional Patent Application Ser. No. 63/345,864 entitled “Geofencing With Backup Controllers” to Singletary et al., filed May 25, 2022, the disclosures of which is herein incorporated by reference in its entirety.

### STATEMENT OF FEDERALLY SPONSORED RESEARCH

This invention was made with government support under Grant No. CNS1932091 awarded by the National Science Foundation. The government has certain rights in the invention.

### FIELD OF THE INVENTION

The present invention generally relates to robotics and more specifically to control systems for robots.

### BACKGROUND

Robotics refer to the design, manufacture, operation, sensory feedback, and information processing of robots. Robots are designed to tackle various types of tasks that are dangerous and unsuitable for human. Certain robots perform actions directed by human input, while some robots can operate autonomously by sensing the world around them and making decisions in response to the environment that surrounds them. Robotics platforms can take any form. Unmanned aerial vehicles (UAVs), also known as drones are a type of robotics platform. Hobby drones or personal drones have gained significant popularity in recent years, as they have become increasingly accessible, and can be fun and engaging for people of various age groups.

Control systems can provide the means to control an output in order to achieve a desired response. There are many ways to classify control systems, including open and closed loop control systems, and continuous time and discrete-time control systems. Closed-loop control systems seek to manage or command the behavior of other devices or systems by incorporating feedback to control one or more outputs of the device or system.

In robotics, control systems can regulate and command the functions of the robotics platform in order to achieve the desired result. The three main components to a robot, including the controller, the sensors, and the actuator(s) can work in a cohesive manner to drive the robot to accomplish its targets or goals. Feedback control systems are typically used as the controller to direct the movements of the robot in an attempt to functions as intended.

### SUMMARY OF THE INVENTION

Systems and methods for high-speed geofencing using control barrier functions in accordance with embodiments of the invention are illustrated. One embodiment includes a robotics platform, a set of one or more motors and at least one sensor. The robotics platform further includes a controller comprising a set of one or more processors, and a memory containing a controller application and a backup controller application, wherein the controller application configures the set of processors to control the robotics platform by performing the steps of receiving user commands, and generating commands controlling the set of one or more motors based on the received commands. The backup controller application configures the set of processors to monitor the controller and intervene as the commands received by the controller direct the robotics platform towards a boundary by performing the steps of defining a safe set identifying positions where the robotics platform is safe, defining an invariant safe set based upon a backup set, where the invariant safe set is a subset of the safe set, and the backup set is a subset of both the invariant safe set and the safe set, receiving commands controlling the set of one or more motors to track to a desired velocity, determining if the robotic platform is approaching a boundary of the invariant safe set, and upon a determination that the robotics platform is approaching a boundary of the invariant safe set, switching control of the motors from the received commands to a combination of the received commands and backup controls generated by the backup controller application.

In another embodiment, the defining the invariant safe set comprises generating the invariant safe set based on an implicit control barrier function.

In a further embodiment, the implicit control barrier function is based upon a flow of the robotics platform within the safe set.

In still another embodiment, the switching control of the motors is regulated by a regulation function.

In a still further embodiment, the regulation function generates a safety filter capable of smoothly switching control from the received commands to the combination of received commands and backup controls as the robotics platform moves closer to boundaries of the invariant safe set.

In yet another embodiment, the switching control of motors further comprises switching control of the motors to the combination of received commands and backup controls in response to a determination by the safety filter that the robotics platform will not move into the safe set based on the flow of the platform.

In a yet further embodiment, the regulation function is Lipschitz continuous in its arguments.

In another additional embodiment, the regulation function is scaled by the inverse of the robotics platform's velocity towards the boundaries at high-speed.

In a further additional embodiment, the switching control of motors further comprises switching control of the motors to the received commands as the robotics platform moves away from boundaries of the invariant safe set.

In another embodiment again, the backup controls have increasingly more control of the motors over the received commands as the robotics platform moves closer to a boundary of the invariant set.

One embodiment includes a method for high-speed geofencing including defining a safe set identifying positions where a robotics platform is safe, defining an invariant safe set based upon a backup set, where the invariant safe set is a subset of the safe set, and the backup set is a subset of both the invariant safe set and the safe set, receiving commands controlling a set of one or more motors on the robotics platform to track to a desired velocity, determining if the robotic platform is approaching a boundary of the invariant safe set, and upon a determination that the robotics platform is approaching a boundary of the invariant safe set, switching control of the motors from the received commands to a combination of the received commands and backup controls generated by the backup controller application.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

The description and claims will be more fully understood with reference to the following figures and data graphs, which are presented as exemplary embodiments of the invention and should not be construed as a complete recitation of the scope of the invention.

FIG. 1 illustrates a process for high-speed geofencing for a robotics platform in accordance with an embodiment of the invention.

FIGS. 2A-B illustrate a platform that can be utilized to implement a high-speed geofencing system and a controller for performing high-speed geofencing to be implemented in the platform in accordance with an embodiment of the invention.

FIG. 3 illustrates a controller that can be used by human pilots to command the robotics platform in accordance with an embodiment of the invention.

FIG. 4 illustrates a flow Φ_{π} of the platform in space and a backup set S_{B} that are used to construct an invariant safe set S_{I} of positions where the platform is safe within the space in accordance with an embodiment of the invention.

FIG. 5 illustrates the practical effects of geofencing enforced during high speed flight in accordance with embodiments of the invention.

FIG. 6 illustrates a blending of control between a human pilot and a backup controller due to a safety filter in accordance with an embodiment of the invention.

FIG. 7 illustrates a comparison between the performance of traditional control barrier functions (CBFs) and a safety filter for high-speed geofencing in accordance with an embodiment of the invention.

FIGS. 8A-D illustrate the testing results of two test scenarios in which a geofencing system in accordance with an embodiment of the invention is utilized.

FIGS. 9 illustrates the testing results in which a system that incorporates a geofencing system is required to respond to repeated commands for the system to approach boundaries of a test region.

### DETAILED DESCRIPTION

Safety is a fundamental concern in the study of robotics. Improper safety measures on robotics platforms can lead to accidents that can cause tremendous property loss and serious injury to humans. Therefore, it is important to design a controller that is able to provide safety guarantees in robotics platforms. For high speed and/or flying robotics platforms such as high-speed aerial racing drones, it can be even more important to have safety guarantees implemented. The Federal Aviation Administration (FAA) regulations stipulates that the legal speed limit for aerial racing drones is 100 miles per hour, and drones used in competitive racing leagues such as The Drone Racing League can go even faster. In most instances, these high-speed aerial racing drones are manually controlled by human pilots. If any loss of control happens at those high rates of speed, the resulting crash can involve a severe impact.

Current works on the safety of aerial racing drones have largely been focused on the planning of safe trajectories. While there have been vision planners developed for quick flights for aerial drones in unknown environments that rely on motion primitives, they have not been applied to the high-speed context as seen in drone racing, as the localization and mapping algorithms are generally unable keep up with the speed of drones operated by humans. Intervention for safety during travelling on a desired trajectory remains a less explored aspect of the safety of high-speed aerial drones. In most cases, this is due to the energy and computational constraints on the part of the racing drones that limit them from performing such interventions during operation. In order to circumvent these constraints, there have been proposed methods that involved a sampling-based model predictive control (MPC) approach that generates many possible safe trajectories at each time-step, and chooses the one closest to the user's desired input subject to safety conditions. Other MPC-based approaches include using learning to minimize conservatism, but neither methods are able to run in real-time on a microcontroller. Control barrier functions (CBF) have recently been proven to provide an effective means of enforcing safety on a wide variety of robotic systems. However, state-of-the-art CBF implementations are also not well-suited for robotics platforms involving high-speed motion as they typically rely on simplified models that either become invalid at high speeds, or have no guarantees of feasibility. Accordingly, there is a need for safety intervention mechanisms for robotics platforms, such as aerial drones, that can operate at high speeds where human operation is involved.

Systems and methods in accordance with various embodiments of the invention can remedy the above issues to achieve safe high-speed motion that involves minimal interventions by utilizing a backup controller that only takes over the controls of a robotics platform when the system deems the current trajectory unsafe based on the commands it receives, thereby giving the human controllers as much freedom and control as possible while providing a safety guarantee. In many embodiments, the system utilizes the backup controller to construct an invariant safe set, where the backup controller is based on an implicit CBF. Using implicit CBFs can guarantee safety in a more computationally efficient manner. The system can use CBFs in conjunction with the backup controller to minimally alter control of the system while maintaining the robotics platform in a safe space. Such a control method can be less computationally complex than traditional CBFs and thus can be run on a simple microcontroller. In numerous embodiments, a smooth regulation function is utilized to perform seamless switching between the human control and the backup controller as the robotics platform approaches boundaries of a safe space, such that the robotics platform is able to stay within the safe space but not get stuck at the boundaries. A “safety filter” based on the regulation function may be generated to allow the human pilot with more latitude in their control of the robotics platform, and thus allowing the human to operate the robotics platform at higher speed, and perform more aggressive maneuvers.

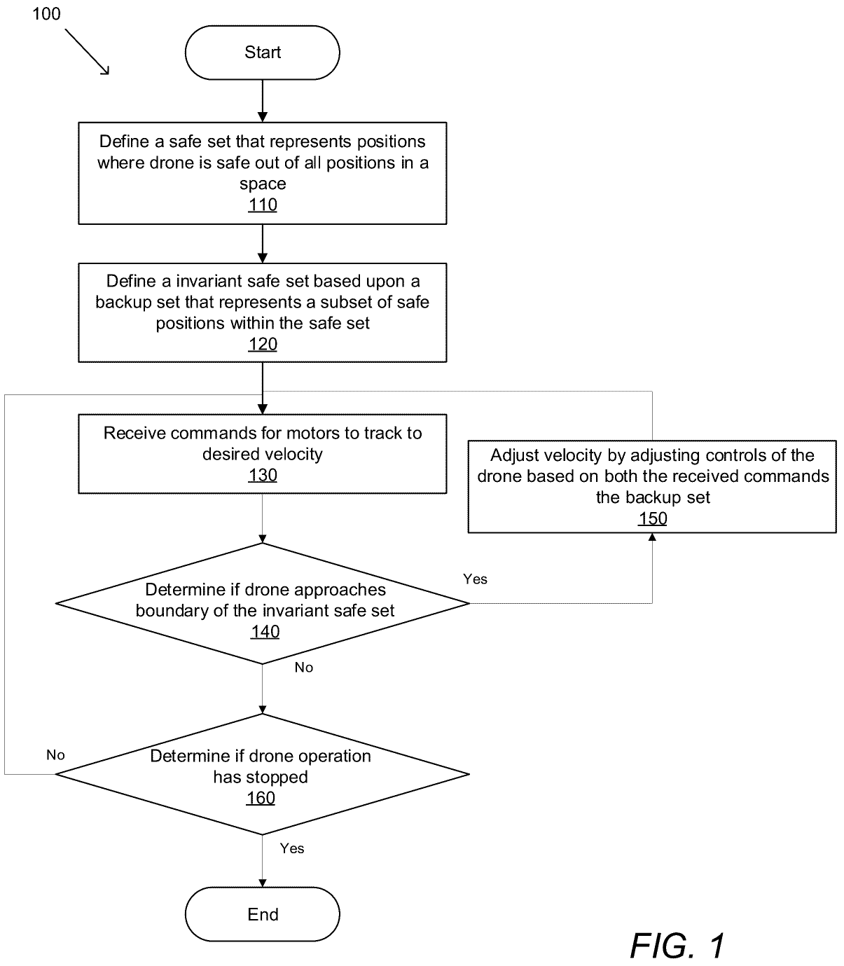

A process for high-speed geofencing for aerial drones in accordance with an embodiment of the invention is illustrated in FIG. 1. The main goal of the system is to prevent crashing and guarantee safety of the aerial drones, and process 100 can define (110) a safe set as a first step towards that goal. The safe set may be defined in a configuration space. In classical mechanics, the parameters that define the configuration of a system are called generalized coordinates, and the space defined by these coordinates is called the configuration space of the physical system. In other words, configuration space refers to the space of possible positions that a physical system may attain. In several embodiments, the safe set represents positions where the drone is safe out of all positions in a given configuration space. The choice of the safe set may be application-driven, and may represent positions where the drone does not collide with obstacles.

Process 100 defines (120) an invariant safe set based on the safe set defined in step 110. An invariant safe set similarly may represent the possible positions that the drone is safe. In many embodiments, the invariant safe set is a subset of the safe set. The invariant safe set may be defined based upon a backup set. In several embodiments, the backup set represents a set of positions where the drone is safe, and the backup set is a subset of both the safe set and the invariant safe set. The backup set may be based upon a backup controller that can take over control of the drone if it is determined that the drone is approaching a boundary of the invariant safe set, and will leave the safe set under current commands that may be input by the human pilot.

Process 100 receives (130) commands for motors on the drone to track to a desired velocity. In numerous embodiments, each of the motors on the drone include a rotor that rotates at particular angular rates and/or rotates to particular angular positions depending on the type of the drone. The motors can convert electrical energy from a power source of the drone to mechanical energy, which can drive the rotor to rotate. In several embodiments, the rotors on the drone are instructed to spin at an angular rate and/or spin to particular angular positions to facilitate the drone to track to the desired velocity. The rotors on the drone can spin at desired angular rates and generate thrusts necessary for the drone to track to the desired velocity. The number of motors on the drone may be varied depending on the type of the drone. The desired velocity may be indicated by the command that was received. In many embodiments, the commands are inputs made by a human pilot as the pilot navigates the drone to a target destination. The commands may be made by the human pilot from a remote controller device, or any other suitable mediums for inputting commands to the drone. In many embodiments, the commands received may originate from another onboard controller, performing tasks including but not limited to guiding the drone through a pre-planned route.

Process 100 determines (140) whether the drone is approaching a boundary of the invariant safe set. In various embodiments, this is performed in response to the onboard sensors detecting that the drone is approaching a boundary. If the sensors on the drone detect that the drone is approaching a certain boundary of the invariant safe set, process 100 can adjust (150) the velocity of the drone by adjusting control of the drone based on both the received commands and the backup set. In many embodiments, the controls of the drone are adjusted by switching control of the motors from the received commands to a combination of the received commands and backup controls generated by the backup controller. The combination can be generated by blending the received commands together with backup controls generated by the backup controller based on the backup set, where the blending is performed using a continuous regulation function in a fashion where the backup controller may gradually take over controls of the drone as the drone approaches a boundary of the invariant set. If the drone is far away from a boundary of the invariant set, the received commands may retain full control of the drone. By including the backup set, the drone can be much less likely to be stuck at the boundaries of the invariant safe set once it manages to stop. In several embodiments, the backup controls direct the drone to move away from the boundary. As the drone approaches a certain boundary of the invariant safe set, steps 140 and 150 involve utilizing the regulation function to transfer control from the human pilot to the backup controller smoothly. The regulation function can generate a “safety filter” that only comes into effect when it deems that there is an eminent risk of the drone leaving the safe set.

Process 100 determines (160) if the drone has stopped its operation. In many embodiments, if the system determines that the drone has not stopped its operation, process 100 can return to step 130 and receive further commands for the motors to track to the input desired velocity. In several embodiments, the drone can receive new inputs from sources including (but not limited to) the human pilot to continue moving towards the target. Process 100 can maintain monitoring the drone as long as the drone remains operating. Steps 130 to 150 may be performed iteratively until process 100 determines that the drone has stopped its operation. In certain embodiments where the drone may stop operation upon reaching a target destination, process 100 may disengage upon a determination that the drone has reached the target destination.

One of ordinary skill in the art will appreciate that similar processes can be utilized with other types of robotics platforms in which a backup controller is used to control the motion of the robotics platform as the robotics platform approaches a defined boundary as appropriate to the requirements of specific applications of embodiments of the invention.

While specific processes for high-speed geofencing using CBFs are described above, any of a variety of processes can be utilized to perform high speed geofencing using CBFs as appropriate to the requirements of specific applications. In certain embodiments, steps may be executed or performed in any order or sequence not limited to the order and sequence shown and described. In a number of embodiments, some of the above steps may be executed or performed substantially simultaneously where appropriate or in parallel to reduce latency and processing times. In some embodiments, one or more of the above steps may be omitted.

### Robotics Platforms for High-Speed Geofencing

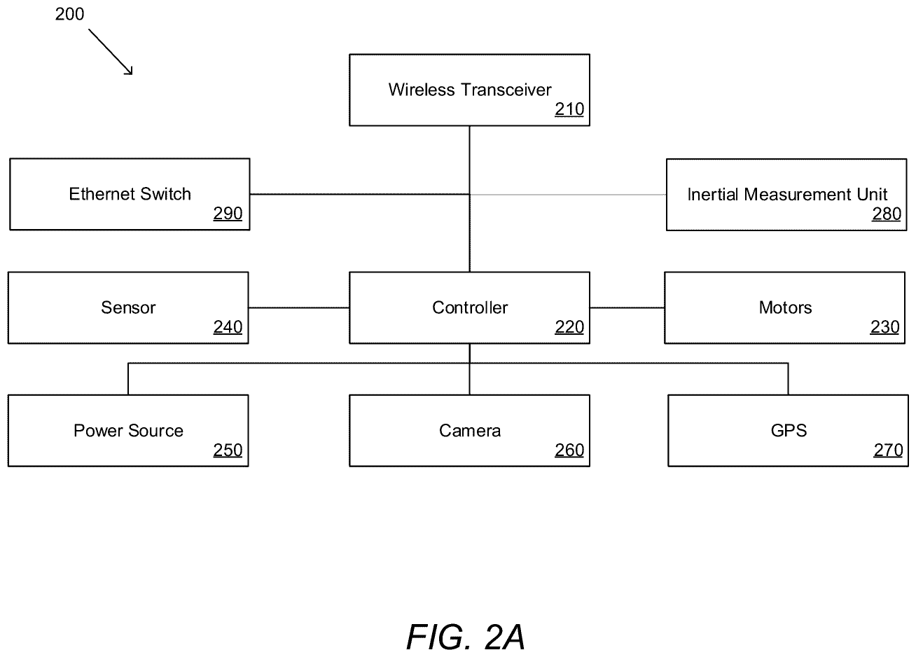

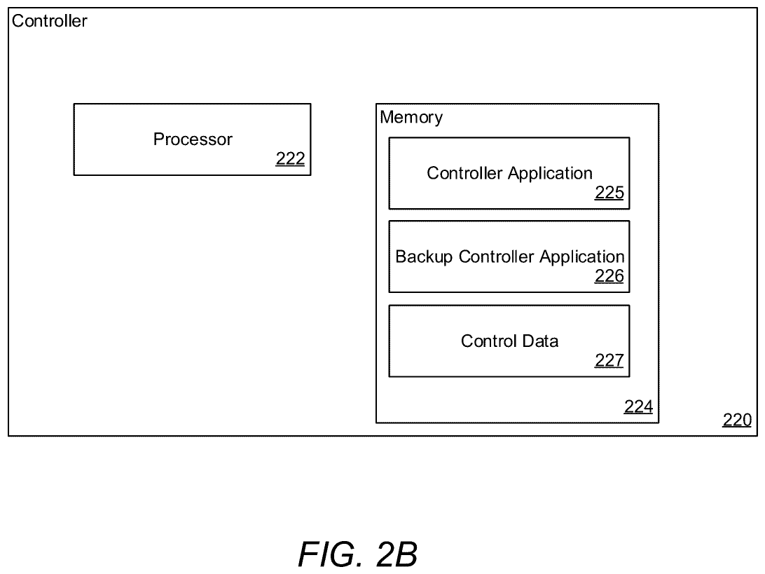

A robotics platform that incorporates high-speed geofencing system in accordance with an embodiment of the invention is illustrated in FIG. 2A. In numerous embodiments, the robotics platform is a high-speed aerial drone with four motors. High-speed aerial drones with different number of motors may be used for this implementation. The robotics platform 200 may include a wireless transceiver 210. In many embodiments, the wireless transceiver 210 is used for receiving commands externally and sending feedback data to external processing devices. Controller 220 may be configured to act as a controller incorporating a backup controller capable of guiding the platform from a starting position to a target destination while keeping the platform within a safe set of positions where the platform is safe within the space. Controller 220 may command a set of one or more motors 230 in such a way as to implement velocity tracking. In a number of embodiments, the number of motors 230 may not be limited to four. Each of the motors 230 may drive a rotor, and each of the motors 230 can convert power provided from power source 250 to facilitate rotation in the rotors. In embodiments where the robotics platform is an aerial drone, the controller may command a set of one or more motors. In certain embodiments, controller 220 may be a single electronic speed controller (ESC) that commands all the motors in the set of one more motors on the aerial drone. In some embodiments, controller 220 may be multiple ESCs, each in charge of commanding the individual corresponding motor in the set of one or more motors. Each of the set of one or more motors on the aerial drone may drive a rotor. The rotor driven by each motor in the set of one or more motors 230 can rotate at a particular angular rate such that the airfoil(s) of the rotor can propel the drone to fly and track to the desired velocity as given by the command. The number of rotors and/or motors on the drone may be varied depending on the type of the drone. Controller 220 can also adjust the angular rates of rotors as a means to control the velocity and path of the aerial drone.

One with ordinary skill in the art will appreciate that the controller to motor architecture discussed above can be applied to other forms of robotics platforms including (but not limited to) fixed-wing drones, single-rotor drones, fixed wing vertical takeoff and landing drones (VTOLs), wheeled robots, bipedal robots, quadrupedal robots, and aquatic drones. In embodiments where the robotics platform is a wheeled robot, controller 220 can command all motors in the set of one or more motors in the wheeled robot. Each of the set of one or more motors on the wheeled robot may have a wheel directly connected to the motor or connected via a gear system to the motor. The one or more motors 230 can rotate at a particular angular rate such that wheels connected to the motor can drive the robot to track to the desired velocity as given by the command. In embodiments where the robotics platform is a bipedal or quadrupedal robot, controller 220 can command all the motors on the motors to spin at an angular rate and/or spin to particular angular positions to facilitate the robot to track to the desired velocity. In embodiments where the robotics platform is an aquatic drone, controller 220 can command all the motors on the motors to spin at an angular rate to propel the drone to track to the desired velocity.

In some embodiments, platform 200 includes at least one sensor 240. In many embodiments, sensor 240 is a lidar. The specific sensors utilized within a robotics platform are largely dependent upon the requirements of a given application and can include (but are not limited to) cameras, sonar, radar, and/or other types of proximity sensors. In several embodiments, sensors 240 may be used by the robotics platform to detect surrounding obstacles and help with collision avoidance. Platform 200 may include a GPS antenna 270 and an inertial measurement unit (IMU) 280 to assist the platform with positioning in multi-dimensional space. Platform 200 may include an ethernet switch 290. Data transmitted and received by wireless transceiver 210 may similarly be transmitted and received using the ethernet switch 290.

In several embodiments, platform 200 includes multiple controllers 220, which can include multiple backup controllers that can receive inputs from other controllers and/or the at least one sensor directly. Controllers 220 can provide one or more outputs to a primary control system for platform 200. In some embodiments, similar hardware can be utilized in any of a variety of robotics platforms including (but not limited to) fixed-wing drones, single-rotor drones, fixed wing vertical takeoff and landing drones (VTOLs), ground drones, bipedal robots, quadrupedal robots, and aquatic drones.

Although a specific example of a robotics platform is illustrated in this figure, any of a variety of robotics platforms can be utilized to perform high-speed geofencing similar to those described herein as appropriate to the requirements of specific applications in accordance with embodiments of the invention.

A controller for performing high-speed geofencing of a robotics platform in accordance with an embodiment of the invention is illustrated in FIG. 2B. In numerous embodiments, controller 220 includes a set of one or more processors 222. Processors 222 can perform velocity tracking and velocity adjustments for the robotics platform to move to the target. Controller 220 may include a memory 224, which stores a controller application 225, and a backup controller application 226. In several embodiments, controller application 225 and/or backup controller application 226 direct processors 222 to perform the velocity tracking and adjustments. In certain embodiments, the backup controller may be a standalone controller with an architecture that is similar to controller 220 illustrated in FIG. 2B. Memory 224 may include a storage for control data 227. Control instructions including the regulation function may be included in control data storage 227. Data from the onboard sensors (e.g. cameras and/or lidar) may similarly be stored in control data storage 227 for the processor 222 to determine whether adjustments to the velocity of the platform is necessary. Control data received externally can also be stored in control data storage 227.

Although specific examples of controllers are described above with reference to FIG. 2B, any of a variety of controllers can be utilized to perform high-speed geofencing similar to those described herein as appropriate to the requirements of specific applications in accordance with various embodiments of the invention.

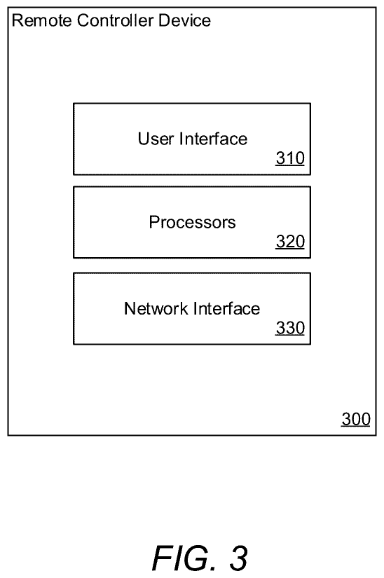

A remote controller device for remotely controlling a robotics platform in accordance with an embodiment of the invention is illustrated in FIG. 3. In numerous embodiments, device 300 includes user interface 310. User interface 310 can receive input from human pilots. Device 300 may include a set of or more processors in charge of sending the input command to the coupled robotics platform for the platform to perform the input command. Device 300 may deliver the input command to the remotely coupled robotics platform through network interface 330.

Although specific examples of a remote controller devices are described above with reference to FIG. 3, any of a variety of remote controller device can be utilized to perform control of a robotics platform similar to those described herein as appropriate to the requirements of specific applications in accordance with various embodiments of the invention. The safe sets and invariant safe sets generated by backup controllers in accordance with various embodiments of the invention are discussed further below.

### Safe Set and Invariant Safe Set

Generally, a nonlinear control-affine dynamic system can be defined as:

\dot{x}=f(x)+g(x)u, (1)

where x∈ [symbol] is the state, u∈U is the control input, to be chosen from an admissible input set U⊆ [symbol] , while f: [symbol] → [symbol] and g: [symbol] → [symbol] describe the dynamics. Given a controller u=p(x) and an initial condition x(t₀)=x₀∈ [symbol] , the solution to this system can be given by a flow map x(t)=Φₚ(x₀, t), t≥t₀, where Φₚ takes an initial state and time of flow and maps to a future state of the closed-loop system under p. The goal of forcing the system to remain in the safe set S at all time can be achieved through the concept of set invariance, where a set S may be deemed invariant if the system stays in the set indefinitely, i.e. ∀t≥t₀, x(t)∈S. S may be control invariant if there exists a control law k: [symbol] →U mapping x to the admissible input set U such that the system is invariant under k, i.e. ∀t≥0, ∀x₀∈S, Φₖ(x₀, t)∈S. A CBF can be used to enforce the set invariance outlined above at each time-step. For a set S⊂ [symbol] defined by a continuously differentiable function h: [symbol] → [symbol] :

S={x∈ [symbol] :h(x)≥0},

∂S={x∈ [symbol] :h(x)=0},

Int(S)={x∈ [symbol] :h(x)>0}.

### h is a CBF for the set if

$$\frac{\partial h}{\partial x} \neq 0$$

for all x∈∂S and there exists an extended class K function α such that for all x∈S, there exists an input u such that:

$${\underbrace{\frac{\partial h}{\partial x} f ( x ) + \frac{\partial h}{\partial x} g ( x ) u}}_{\dot{h} ( x , u )} \geq - α ( h ( x ) ) . \qquad ( 2 )$$

By choosing an input u such that (2) holds, the invariance of S can be guaranteed. Therefore, given an input from the human pilot or another preexisting controller u_{des}(x, t), the closest input u*(x, t) to u_{des}(x, t) that guarantees safety can be chosen by solving the following quadratic program (QP):

$${u}^{*} ( x , t ) = {arg min}_{u ∈ U} {‖ u - {u}_{des} ( x , t ) ‖}^{2} \qquad ( 3 )$$

$$s . t . \frac{\partial h}{\partial x} f ( x ) + \frac{\partial h}{\partial x} g ( x ) u \geq - α ( h ( x ) ) .$$

CBFs generally work well for maintaining set invariance. However, they can be restricted in their usage due to the difficulty in constructing an invariant set S. Almost all of the current state-of-the-art methods for computing such sets for nonlinear systems suffer heavily from the complexity of dimensionality, and may be inapplicable to drones without model simplification.

In numerous embodiments, the backup set approach assumes knowledge of a very small backup set S_{B} that is invariant under some backup controller π(x), which can serve as a remedy to the difficulty of obtaining control invariant sets. This can be a set describing the hovering maneuver for the drone and a controller commanding the drone to stop and hover in place. With the small backup set defined, a point x₀∈S may be in the invariant safe set S_{I} if the system is able to reach the backup set S_{B} over some time T without leaving the safe set S under the predefined backup controller. The invariant safe set may become:

$${S}_{I} = \{ {x}_{0} ∈ {ℝ}^{n} \vert {Φ}_{π} {( {x}_{0} , τ )}_{∀ τ ∈ [ 0 , T ]} ∈ S ∧ {Φ}_{π} ( {x}_{0} , T ) ∈ {S}_{B} \} \qquad ( 4 )$$

where Φ_{π}(x₀, t) is the flow of the system from initial condition x₀ after time t, governed by \dot{x}=f(x)+g(x)π(x)=f_{π}(x), where π(x) is the backup control policy.

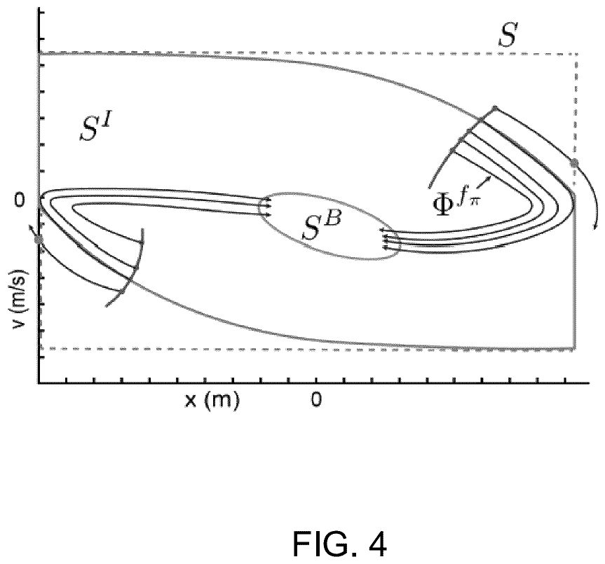

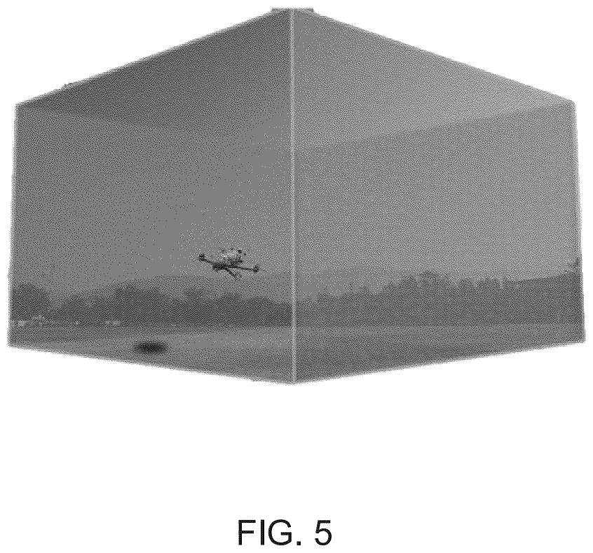

FIG. 4 illustrates a flow Φ_{π} of the platform in space and a backup set S_{B} that can be used to construct the invariant safe set S_{I} in accordance with an embodiment of the invention. The backup set generated by a regular backup controller can approach the size of the maximal invariant safe set. However, for high speed operation (e.g. drone racing), where the high speed of the robotics platform is coupled with limited onboard computational ability, these types of CBFs may not a realistic option to construct the invariant safe set S_{I}. This is due to the computationally expensive gradient computation at each time-step to determine

$$\frac{\partial h}{\partial x} .$$

In many embodiments, the geofencing system is able to leverage implicit control barrier functions (ImCBFs) to construct the invariant safe set based on the flow of the system with low computational complexity. Additional details to constructing the invariant safe set is discussed further below.

### Regulation Function and Smooth Transition

For safe set S and backup set S_{B} that are zero super-level sets of smooth functions h(x) and h_{B}(x), S_{I} in (4) may be defined as:

$${S}_{I} = \{ x ∈ {ℝ}^{n} \vert ( h ( {Φ}_{π} {( x , τ )}_{∀ τ ∈ [ 0 , T ]} ) \geq 0 ) ∧ ( {h}_{B} ( {Φ}_{π} ( x , T ) ) \geq 0 ) \} . \qquad ( 5 )$$

Additionally, it is known that:

$${S}_{I} = \{ x ∈ {ℝ}^{n} \vert {min}_{τ ∈ [ 0 , T ]} \{ h ( {Φ}_{π} ( x , τ ) ) , {h}_{B} ( {Φ}_{π} ( x , T ) ) \} \geq 0 \} . \qquad ( 6 )$$

An implicit control barrier function (ImCBF) h_{I} for a control system (1) with flow map Φ_{π}(x, T) associated with a backup controller u=π(x) may be defined as

$${h}_{I} ( x ) := {min}_{τ ∈ [ 0 , T ]} \{ h ( {Φ}_{π} ( x , τ ) ) , {h}_{B} ( {Φ}_{π} ( x , T ) ) \} . \qquad ( 7 )$$

In some embodiments, the safe set given as in (6): S_{I}={x∈ [symbol] |h_{I}(x)≥0} is associated with the ImCBF. The ImCBF h_{I} can be implicitly defined as it relies on the flow map of the system, which is also implicit. h_{I} can be evaluated by forward simulating the system under the backup controller.

The QP in (3) constrained with the ImCBF h_{I} may be denoted as backup CBF QP. While invariance could be enforced using the backup CBF QP, the implicitly defined CBF can require additional computation power to solve. Typically, the backup CBF QP may not be achievable in real-time without a desktop-grade CPU. Therefore, a simplification may be made in order to guarantee safety with a low-weight, low-power microcontroller (e.g. a microcontroller suitable for a small racing drone, such as the Teensy 4). The backup controller can be utilized directly to accomplish a smooth transition. Rather than switching to the backup controller when the system is about to leave S_{I}, the system can smoothly switch between the desired controller and the backup controller as the boundary of S_{I} is approached. A function that can be used to regulate this smooth switching is the regulation function, denoted by k(x, h_{I}(x)). If:

k(x, 0)=π(x)∀x∈S_{I}, (8)

holds for backup control law π(x), then a closed-loop system under k(x, h_{I}(x)) is forward invariant, meaning that the closed-loop system under k(x, h_{I}(x)) is safe for an open-loop system (1) under a continuous control law given by k(x, h_{I}(x)). In other words, if the system that is regulated by the regulation function at any position within the invariant safe set can move towards and into the backup set, then the particular position that the system is at can be considered safe, and the backup controller need not take over the controls. Additionally, to improve performance, the system may require that for h_{I}(x)>>0, k(x, h_{I}(x))=u_{des}(x). In this fashion, the filter may not modify pilot's actions unless there is an eminent risk of leaving the safe set.

Other than the reduced computational complexity, there are several advantages to using a regulation function. Unlike CBFs, there is no notion of relative degree for the input, and therefore regulation functions can provide complete freedom in the choice of h(x). Moreover, input bounds can be handled trivially as, by design, π(x)∈U can be chosen, and k can be constructed such that the input bound is always satisfied. Additionally, if k(⋅, ⋅) is locally Lipschitz in its arguments, and the dynamics under the backup controller f_{π} are continuous and bounded on S, then the resulting filter k(x, h_{I}(x)) is locally Lipchitz continuous. The locally Lipschitz property can reduce discontinuous inputs and guarantee smoother control inputs while switching.

There are two requirements to the regulation function, which are: (i) the backup controller π(x) is applied when h_{I}(x)=0, and (ii) it is Lipschitz continuous in its arguments. When h_{I}(x)>0, it can be desirable for the filter to mimic u_{des}(x) as much as possible. A mixing function is chosen to achieve this:

k(x, h_{I}(x))=λ(x, h_{I}(x))u_{des}(x)+(1−λ(x, h_{I}(x)))π(x), (9)

for λ(x, h_{I}(x)): [symbol] × [symbol] →[0, 1].

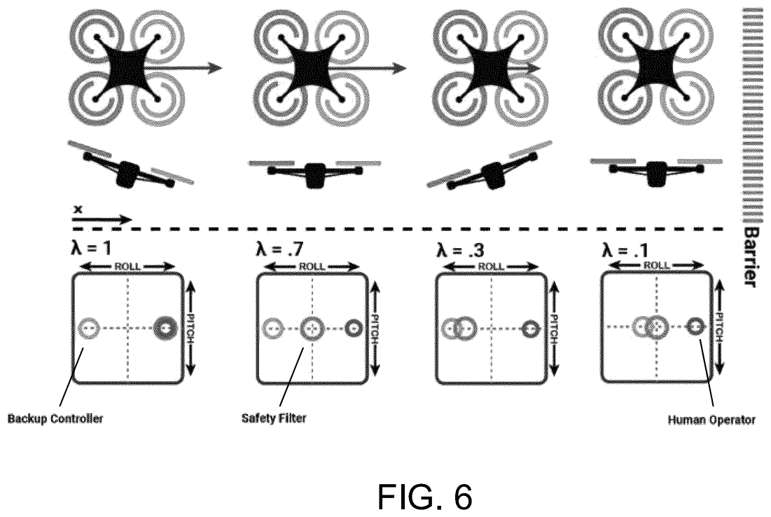

FIG. 6 illustrates a blending of control between a human pilot and a backup controller due to a safety filter in accordance with an embodiment of the invention. When λ(x, h_{I}(x))=1, the human pilot is in complete control. As the drone approaches the wall, the value of λ(x, h_{I}(x)) decreases, and it begins to slow down. Finally, a steady-state is reached between the operator's control action and the backup control action near the boundary, and the drone stops. In many embodiments, the backup controller attempts to move the drone away from the boundary, which is important such that the system does not get “stuck” near the boundary, meaning that λ is always greater than 0.

The function may match u_{des}(x) exactly when h_{I}(x)>>0 to allow for maximum freedom of the operator. In some embodiments, this is achieved by exploiting the exponential function:

λ(x, h_{I}(x))=1−exp(−βh_{I}⁺(x)), (10)

where constant β is used to tune how quickly the function λ(x, h_{I}(x)) decays, and h_{I}⁺(x)=max(h_{I}(x), 0) ensures that λ(x, h_{I}(x))∈[0, 1]. With this safety filter, the desired behavior of λ(x, h_{I})≈1 can be achieved, while providing a smooth decay to 0 when h_{I}(x)→0. The constant β can be used to tune how quickly the function λ decays.

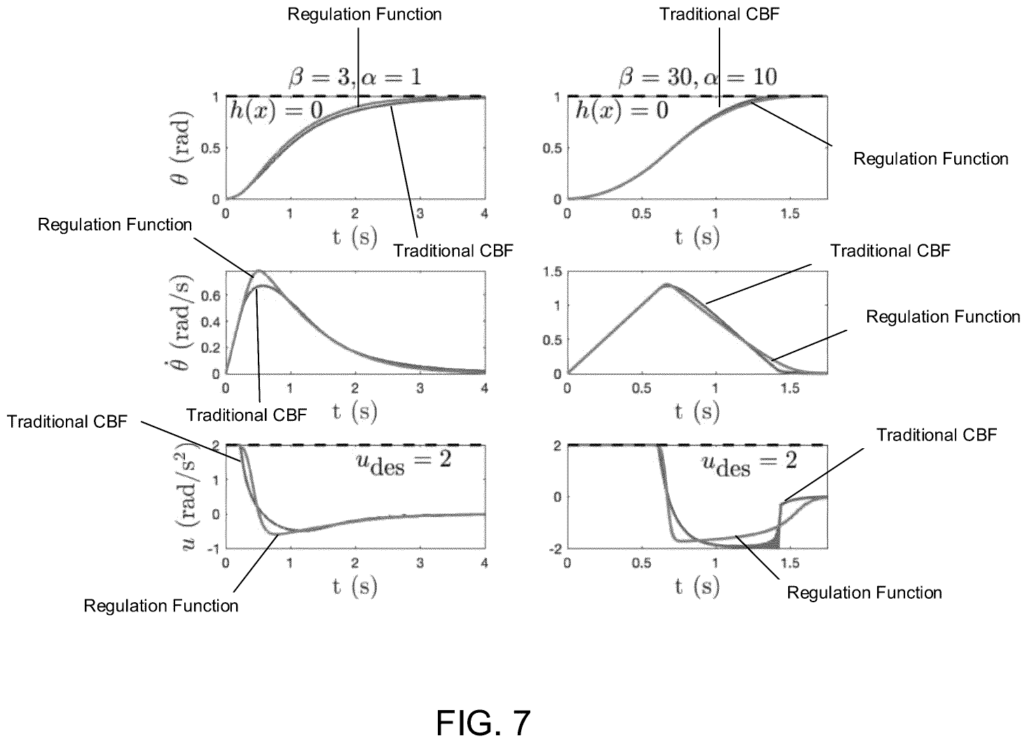

The performance of the combination of backup controller and safety filter can be compared the performance of the traditional backup set CBF approach. FIG. 7 illustrates a comparison between the performance of traditional CBFs and the use of a safety filter for high-speed geofencing in accordance with an embodiment of the invention. The two relevant metrics for this comparison are the computational times and the conservatism, as both methods provide guarantees of safety. Due to the freedom in the selection of both λ(x) and k(x) these functions can be chosen independently to result in smooth transitions when approaching the boundary of the invariant safe set, while minimizing conservatism.

Two benefits of the smooth filter can be seen in this comparison. While the filtering performance is similar, the regulation function can be an order of magnitude faster to evaluate. Moreover, when the gains are increased to allow a rapid approach of the boundary of the invariant safe set, the CBF begins to oscillate near the boundary, whereas the smooth filter does not suffer from such behavior. These oscillations may occur due to numerical instability of the optimization problem as the system pushes against the boundary of the invariant safe set.

### Implementation of Geofencing System

Systems and methods for performing high-speed geofencing in accordance with various embodiments of the invention can be implemented in any of a variety of robotics platforms. The operation of backup controllers to perform high-speed geofencing can be illustrated by considering the specific example of racing drones. Flight controllers on modern racing drones are capable of tracking desired angular rates extremely well. With the availability of low-cost, high-speed ESCs and rate gyros, state-of-the-art controllers can track angular rates at control frequencies of 8 kHz. Rather than controlling the torques of the motors as inputs, the system can control the throttle and angular rates as inputs to the closed-loop system of the drone. This choice of architecture can greatly simplify the task of modeling the drone dynamics, and can filter the system in a way that minimizes the impact on the human pilot. In some embodiments, the same filter architecture can be applied to different drones with different dynamics, including but not limited to those with six or eight motors. By modeling the response of the system to desired angular rate commands, the system does not rely on perfect angular rate tracking. In selected embodiments, this choice also allows for the accounting of any delay in the filter arising out of the communication between the sensors and the onboard flight controller.

In example simulations, the drone and flight controller system are modelled as rigid body motion in the Special Euclidean Group in 3 dimensions, SE(3). In some embodiments, the state-space model x∈ [symbol] is chosen to be x=[p_{ω}, q, v_{ω}, ω_{b}]^{T} where p_{ω}=[x, y, z]^{T} is the position in the world frame, v_{ω}=[vₓ, v_{y}, v_{z}]^{T} are the world-frame velocities, q is the quaternion representation of the orientation with respect to the world frame, and ω_{b}=[ωₓ, ω_{y}, ω_{z}]^{T} are the body-frame angular velocities. To model the system's response to an angular rate command, the derivative of the angular rates can be set to:

\dot{ω}=C(x)(ω_{des}−ω), (11)

where C(x): [symbol] → [symbol] is a (potentially state-dependent) function that determines how quickly the desired rates are tracked. For a well-tuned racing drone with minimal filter delay, the value of the derivative of the angular rates may be on the order of 50, and can be treated as state-independent. Lastly, to map the throttle command to thrust, a second-order polynomial with data from the accelerometer and GPS can be fitted. While this mapping may be dependent on the voltage, the inclusion of an integral term in the altitude controller can generally be sufficient to eliminate any drift.

In many embodiments, the safe set to constrain the position of the drone inside a large polytope in the 3D space, where the human pilot has almost complete control, but is unable to steer the drone out of the space can be defined as:

h(x)=min{rₓ²−(x−x_{c})², [symbol] −( [symbol] − [symbol] )²,r_{z}²−(z−z_{c})²}, (12)

which is positive inside of a box with side lengths (rₓ,r_{y}, r_{z}) centered at (x_{c}, [symbol] , z_{c}), and negative outside. In many embodiments, the backup controller π(x) is a velocity controller on SE(3). The backup controller can attempt to bring the drone to zero velocity in the x, [symbol] , z. In some embodiments, the backup controller is in charge of bringing the drone away from the boundary if it is too close. If the drone were to simply stop at the boundary, it would be stuck at the edge of the safe set due to λ(x) approaching 0. For the backup controller to achieve these two goals, the desired velocity can be set to

$${v}_{x} = \{ \begin{matrix}0 & {r}_{x}^{2} - {( x - {x}_{c} )}^{2} \geq δ , \\ - ( δ - {r}_{x}^{2} + {( x - {x}_{c} )}^{2} ) & otherwise\end{matrix} . \qquad ( 13 )$$

Under this backup controller, the drone can move a distance δ from the boundary before stopping. The desired velocities are identical for y and z directions. The backup set S_{B} can be defined by the function:

h_{B}=−\sqrt{vₓ²+ [symbol] +v_{z}²}+ϵ. (14)

In several embodiments, this backup set ensures that the drone is able to slow itself to a speed of ϵ, chosen to be 0.1 m/s, thus guaranteeing that the drone is able to stop before hitting the boundary.

In selected embodiments, modifications are made to the function (10) to perform better at very high-speeds. This may be due to the need for β to be made large to enable the drone to have smooth breaking at high speeds, but would make the filter overly conservative near the boundary at low speeds. This can be fixed by scaling the value of h_{I}(x) by the inverse of the velocity towards the barrier. The regulation function used by the drone is:

$$λ ( x , {h}_{I} ( x ) ) = 1 - exp ( - \frac{β {{h}_{I} ( x )}^{+}}{{v}_{⊥}^{+}} ) , \qquad ( 15 )$$

where v_{⊥} is the velocity in the direction of the barrier.

### Example Simulation

An example quadrotor was built for testing. The example quadrotor was built on a Chimera 7″ frame with four iFlight XING X2806.5 1300 KV brushless motors, a T-Motor F55A Pro II 4-inl ESC, a MAMBA BASIC F722 Flight Controller (FC), a Teensy 4.1 microcontroller, a Vectornav VN-200 IMU+GPS, a FrSky R-XSR receiver, a DJI FPV air unit, and a Cadex FPV camera. The quadrotor includes a FrSky QX7 radio to send desired angular rates commands to Teensy microcontroller through the receiver. The VN-200 fuses GPS and IMU data with a built in extended Kalman filter. This data is sent to the Teensy as navigation data at 400 Hz. Using this data, the microcontroller is capable of modifying these angular rates commands with the regulation function and then forwards them on to the FC. The FC runs betaflight, an open source software, to track the commanded angular rates. The PID loop runs at the gyro update rate at 8 kHz. The FC sends digital commands to the ESC using DSHOT600 at the same 8 kHz. FPV video is digitally streamed with an end to end latency of 25 ms from the DJI FPV air unit to DJI FPV goggles, which are worn by the operator.

To simplify the transition from simulation to hardware, the barrier functions are first generated in MATLAB for simulation, and then codegen is used to create C++code that will run on hardware. The execution time of the filter on the Teensy is approximately 350 μs. The algorithm runs at the update rate of the navigation data, which is 400 Hz.

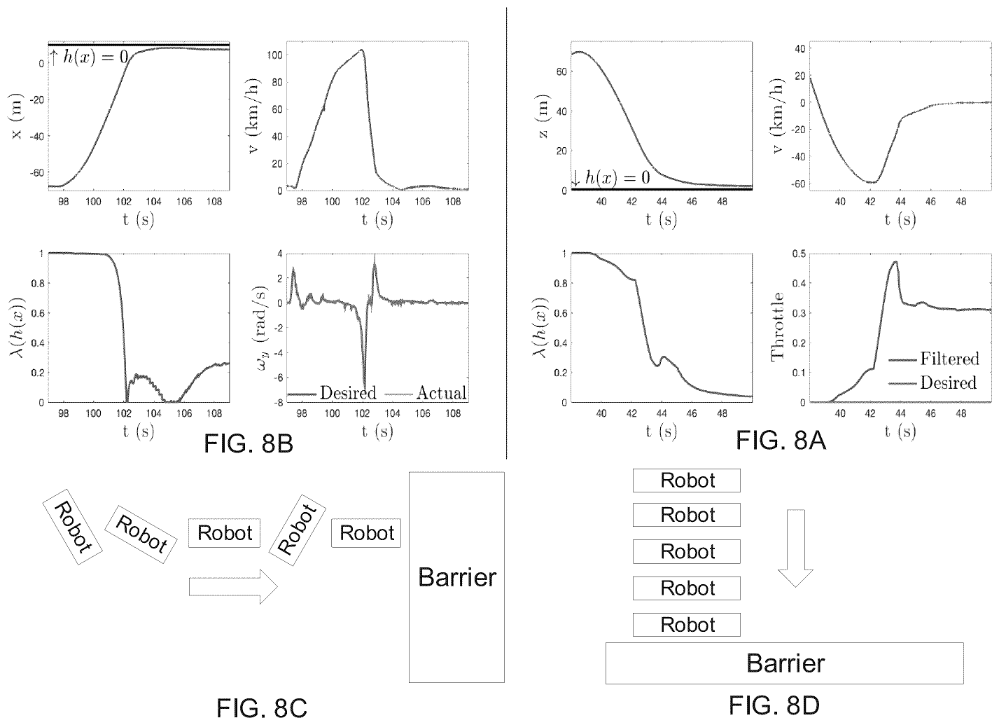

A large number of flight tests were done to verify the safety guarantees provided by the system. FIGS. 8A-D illustrates the hardware testing results of two test situations where the geofencing system was tested on in accordance with an embodiment of the invention. In the first test, the pilot commanded the drone to head north at high speeds. The active component of the barrier was 40 m north of the initial position. The drone was able to reach a top speed of 104 km/h, before beginning to break at a distance of 15 m from the barrier. The pilot attempted to push the drone past the barrier, but was stopped at a minimum distance of 1.7 m from the barrier. Due to this, the pilot was then able to safely move away from the restricted airspace. As illustrated in FIG. 8C, the controller was able to hold the drone away from the barrier despite the human piloting commanding different desired inputs than the simulation. This is, in part, due to the very accurate angular rate tracking showcased at the bottom right of FIG. 8A. While there is a slight delay in this tracking, this is properly modeled in (11), thus it does not affect our ability to guarantee safety. FIGS. 8C and D show the drone throughout this maneuver. Above this, the orientation of the drone at different snapshots are visualized. As shown, the drone reaches an angle of nearly 90° while breaking.

The second case has the pilot flying at an altitude of 70 m and then sends no commands, mimicking a loss of radio connection. The barrier was chosen to be a distance of 0.5 m from the ground. After a short free-fall, reaching a vertical velocity of −60 km/h, the safety filter stabilizes the drone before coming to a stop at a distance of 1.8 m above the ground. The data from this flight is visualized in FIG. 8B. Rather than plotting desired angular rates, the desired throttle of the drone sent from the user is compared to the throttle produced by the safety filter. As shown in FIG. 8D, despite the pilot commanding no throttle for the entire duration of the descent, the drone is able to smoothly recover before crashing.

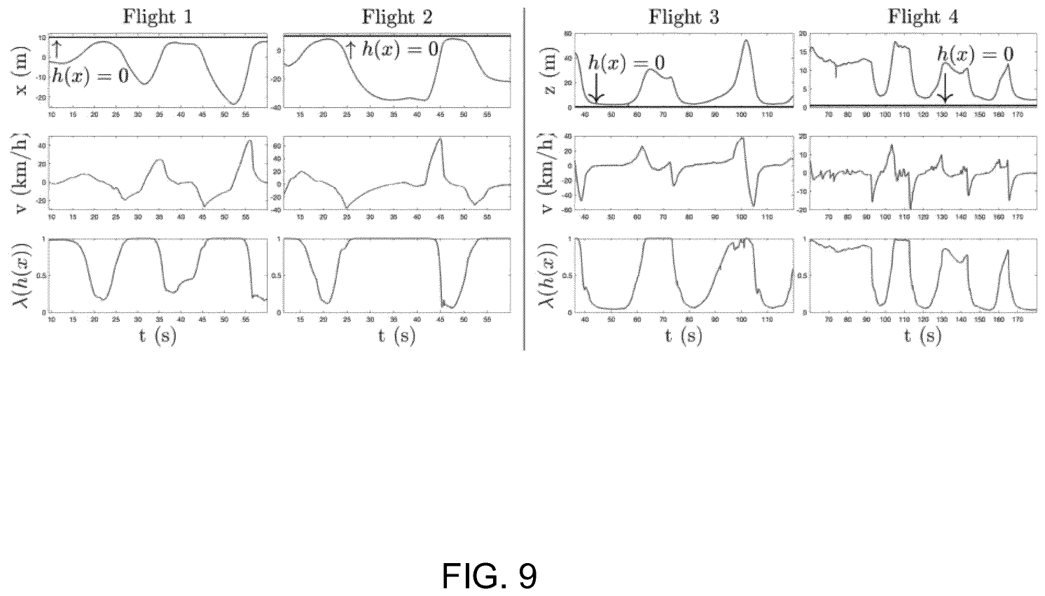

FIG. 9 illustrates the testing results of the additional hardware testing where the geofencing system was implemented and system responses to repeated commands for the system to approach the boundaries of the test region in accordance with an embodiment of the invention. FIG. 9 highlights the reliability and consistency of this method in the application of geofencing. Four separate flights are plotted, two of which approached the horizontal barrier and two approached the vertical barrier. In each flight, the barrier is approached two to four times, and every time, safety is maintained, and A never reaches zero, meaning the pilot never lost complete control of the drone for any period of time.

Although specific methods of high-speed geofencing are discussed above, many different methods of high-speed geofencing can be implemented in accordance with many different embodiments of the invention. For example, one of ordinary skill in the art will appreciate that methods of high-speed geofencing can be implemented on other robotics platforms as appropriate to the requirements of specific applications of embodiments of the invention. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A robotics platform, comprising:
a set of one or more motors;
at least one sensor; and
a controller comprising a set of one or more processors and a memory containing a controller application and a backup controller application, wherein the controller application configures the set of processors to control the robotics platform by performing the steps of:
receiving user commands; and
generating commands controlling the set of one or more motors based on the received commands; and
wherein the backup controller application configures the set of processors to monitor the controller and intervene as the commands received by the controller direct the robotics platform towards a boundary by performing the steps of:
defining a safe set identifying positions where the robotics platform is safe;
defining an invariant safe set based upon a backup set, where the invariant safe set is a subset of the safe set, and the backup set is a subset of both the invariant safe set and the safe set;
receiving commands controlling the set of one or more motors to track to a desired velocity;
determining if the robotic platform is approaching a boundary of the invariant safe set; and
upon a determination that the robotics platform is approaching a boundary of the invariant safe set, switching control of the motors from the received commands to a combination of the received commands and backup controls generated by the backup controller application.

2. The platform of claim 1, wherein defining the invariant safe set comprises generating the invariant safe set based on an implicit control barrier function.

3. The platform of claim 2, wherein the implicit control barrier function is based upon a flow of the robotics platform within the safe set.

4. The platform of claim 1, wherein switching control of the motors is regulated by a regulation function.

5. The platform of claim 4, wherein the regulation function generates a safety filter capable of smoothly switching control from the received commands to the combination of received commands and backup controls as the robotics platform moves closer to boundaries of the invariant safe set.

6. The platform of claim 5, wherein switching control of motors further comprises switching control of the motors to the combination of received commands and backup controls in response to a determination by the safety filter that the robotics platform will not move into the safe set based on a flow of the platform.

7. The platform of claim 4, wherein the regulation function is Lipschitz continuous in its arguments.

8. The platform of claim 4, wherein the regulation function is scaled by the inverse of the robotics platform's velocity towards the boundaries at high-speed.

9. The platform of claim 4, wherein switching control of motors further comprises switching control of the motors to the received commands as the robotics platform moves away from boundaries of the invariant safe set.

10. The platform of claim 1, wherein the backup controls have increasingly more control of the motors over the received commands as the robotics platform moves closer to a boundary of the invariant set.

11. A method for high-speed geofencing comprising:
defining a safe set identifying positions where a robotics platform is safe;
defining an invariant safe set based upon a backup set, where the invariant safe set is a subset of the safe set, and the backup set is a subset of both the invariant safe set and the safe set;
receiving commands controlling a set of one or more motors on the robotics platform to track to a desired velocity;
determining if the robotic platform is approaching a boundary of the invariant safe set; and
upon a determination that the robotics platform is approaching a boundary of the invariant safe set, switching control of the motors from the received commands to a combination of the received commands and backup controls generated by a backup controller application.

12. The method of claim 11, wherein defining the invariant safe set comprises generating the invariant safe set based on an implicit control barrier function.

13. The method of claim 12, wherein the implicit control barrier function is based upon a flow of the robotics platform within the safe set.

14. The method of claim 11, wherein switching control of the motors is regulated by a regulation function.

15. The method of claim 14, wherein the regulation function generates a safety filter capable of smoothly switching control from the received commands to the combination of received commands and backup controls as the robotics platform moves closer to boundaries of the invariant safe set.

16. The method of claim 15, wherein switching control of motors further comprises switching control of the motors to the combination of received commands and backup controls in response to a determination by the safety filter that the robotics platform will not move into the safe set based on a flow of the platform.

17. The method of claim 14, wherein the regulation function is Lipschitz continuous in its arguments.

18. The method of claim 14, wherein the regulation function is scaled by the inverse of the robotics platform's velocity towards the boundaries at high-speed.

19. The method of claim 14, wherein switching control of motors further comprises switching control of the motors to the received commands as the robotics platform moves away from boundaries of the invariant safe set.

20. The method of claim 11, wherein the backup controls have increasingly more control of the motors over the received commands as the robotics platform moves closer to a boundary of the invariant set.
